(19) United States
(12) Patent Application Publication
(10) Pub. No.: US 2008/0219722 A1
(43) Pub. Date: Sep. 11, 2008

(54) FIXING DEVICE AND FIXING METHOD OF IMAGE FORMING APPARATUS

(75) Inventors: Toshihiro Sone, Kanagawa-ken (JP); Osamu Takagi, Tokyo (JP); Satoshi Kinouchi, Tokyo (JP); Yoshinori Tsueda, Shizuoka-ken (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/684,258

(22) Filed: Mar. 9, 2007

(51) Int. Cl. G03G 15/20

(52) U.S. Cl. 399/328

(57) ABSTRACT

In a fixing device of an image forming apparatus of the present invention, inner surfaces of upper and lower frames for respectively supporting a heat roller and a pressure roller are formed as a mirror surface. Between the heat roller and an infrared temperature sensor, an infrared transmission filter for cutting infrared rays beyond a wave length zone equivalent to a heatable area of the heat roller is installed. Detection results of a surface temperature of the heat roller by the infrared temperature sensor are prevented from exceeding the error tolerance due to infrared rays radiated from other than the heat roller. Temperature control for the heat roller is improved and a fixed image of high image quality is obtained.

### BACKGROUND OF THE INVENTION

1. Field of the Invention

The present invention relates to a fixing device of an image forming apparatus such as a copier, a printer, or a facsimile which is loaded therein for heating and fixing a toner image and a fixing method for the image forming apparatus.

2. Description of the Background

As a fixing device used for an image forming apparatus such as an electro-photographic copier or a printer, there is a fixing device available for inserting a sheet of paper through a nip formed between a pair of rollers composed of a heat roller and a pressure roller or similar belts and heating, pressurizing, and fixing a toner image. In such a heating type fixing device, to keep the heat roller at a constant fixable temperature, the surface temperature of the heat roller is detected by a temperature sensor and a heating source is controlled so as to be turned on or off according to detection results.

As a temperature sensor, in recent years, as an infrared temperature sensor, a non-contact temperature sensor for detecting temperature without making contact with non-heated members of the heat roller and fixing belt is used. A non-contact infrared temperature sensor using a thermopile does not damage the surfaces of the heated members and can lengthen the life span of the heat roller.

However, when such a non-contact infrared temperature sensor is used, not only infrared rays emitted from the surfaces of the heated members but also infrared rays radiated from other than the surfaces of the heated members enter the conventional infrared temperature sensor by irregular reflection. Therefore, there is a risk that the infrared temperature sensor may detect the temperatures of the heated members as temperatures different from the actual temperatures.

Therefore, in a fixing device for detecting the surface temperatures of the heated members by the non-contact infrared temperature sensor, development of a fixing device of an image forming apparatus for preventing an incorrect detection of temperature caused by irregular reflection and incidence of infrared rays other than the infrared rays radiated from the heated members, thereby detecting the temperatures of the heated members with high precision, controlling exactly the temperatures of the heated members, improving the fixing property of the heated members, and obtaining a high image quality is desired.

### SUMMARY OF THE INVENTION

An object of the embodiments of the present invention, in a fixing device for detecting the surface temperatures of heated members by a non-contact infrared temperature sensor, is to prevent infrared rays other than infrared rays radiated from the heated members from entering a temperature sensor. By doing this, the temperature sensor is not influenced by infrared-ray energy radiated from other than the heated members and detects the surface temperatures of the heated members with high precision. As a result, on the basis of the highly precise detection results, the temperature sensor controls the temperatures of the heated members with high precision, thus a high image quality due to a satisfactory fixing property is obtained.

According to the embodiments of the present invention, there is provided a fixing device of an image forming apparatus comprising a heated member to make contact with a fixed medium and fix a toner image on the fixed medium; a heat source member to heat the heated member; a non-contact temperature detection member to detect a surface temperature of the heated member; and a prevention member provided between the heat source member and the temperature detection member to prevent infrared rays from other than the heated member from entering the temperature detection member.

### BRIEF DESCRIPTION OF THE DRAWINGS

FIG. 1 is a schematic block diagram showing the image forming apparatus of the first embodiment of the present invention;

FIG. 2 is a schematic block diagram of the fixing device of the first embodiment of the present invention viewed in the axial direction of the heat roller;

FIG. 3 is a schematic layout of the fixing device of the first embodiment of the present invention viewed in the perpendicular direction to the shaft of the heat roller;

FIG. 4 is a schematic illustration showing the infrared transmission filter of the first embodiment of the present invention;

FIG. 5 is a schematic illustration showing the infrared temperature sensor of the first embodiment of the present invention;

FIG. 6 is graphs showing the wave length range of the infrared transmission filter of the first embodiment of the present invention;

FIG. 7 is graphs showing comparison of the radiation rate of infrared rays of the upper and lower frames with a comparative example of the first embodiment of the present invention;

FIG. 8 is a table showing the relationship between the transmission rate of infrared rays of the infrared transmission filter and the detection temperature by the infrared sensor of the first embodiment of the present invention;

FIG. 9 is graphs showing the relationship between the transmission rate of infrared rays of the infrared transmission filter and the detection temperature by the infrared sensor of the first embodiment of the present invention;

FIG. 10 is a schematic block diagram of the fixing device of the second embodiment of the present invention viewed in the axial direction of the heat roller; and

FIG. 11 is a schematic illustration showing the duct of the second embodiment of the present invention.

### DETAILED DESCRIPTION OF THE INVENTION

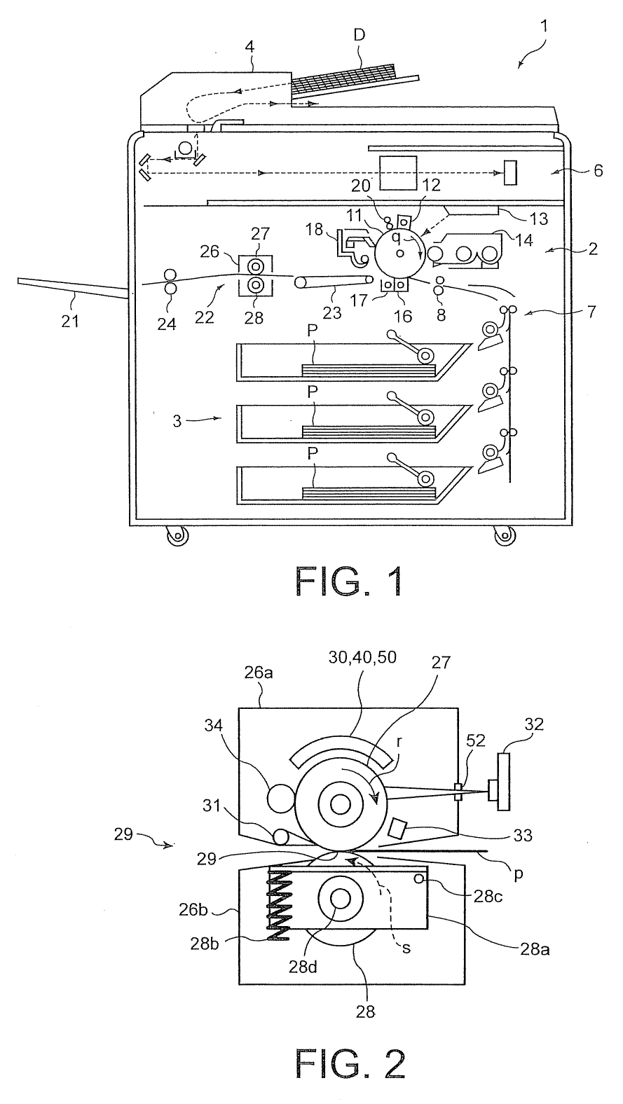

The embodiments of the present invention will be explained below in detail with reference to the accompanying drawings. FIG. 1 is a schematic block diagram showing an image forming apparatus 1 having a loaded fixing device 26 of the embodiments of the present invention. The image forming apparatus 1 includes a cassette mechanism 3 for supplying a sheet P which is a fixed medium to an image forming unit 2 and a scanner unit 6 on the top for reading a document D supplied by an automatic document feeder 4. On a conveying path 7 from the cassette mechanism 3 to the image forming unit 2, aligning rollers 8 are installed.

The image forming unit 2, around a photosensitive drum 11, includes a main charger 12 for uniformly charging the photosensitive drum 11 sequentially in the rotational direction of an arrow q of the photosensitive drum 11, a laser exposure device 13 for forming a latent image on the charged photosensitive drum 11 on the basis of image data from the scanner unit 6, a developing device 14, a transfer charger 16, a separation charger 17, a cleaner 18, and a discharging LED 20. The image forming unit 2 forms a toner image on the photosensitive drum 11 by an image forming process by the well-known electro-photographic method and transfers it to the sheet P.

On the down stream side of the image forming unit 2 in the conveying direction of the sheet P, a sheet ejection conveying path 22 for conveying the sheet P with the toner image transferred to toward a sheet ejection unit 21 is installed. On the sheet ejection conveying path 22, a conveying belt 23 for conveying the sheet P separated from the photosensitive drum 11 to the fixing device 26 and ejection rollers 24 for ejecting the sheet P passing the fixing device 26 to the sheet ejection unit 21 are installed.

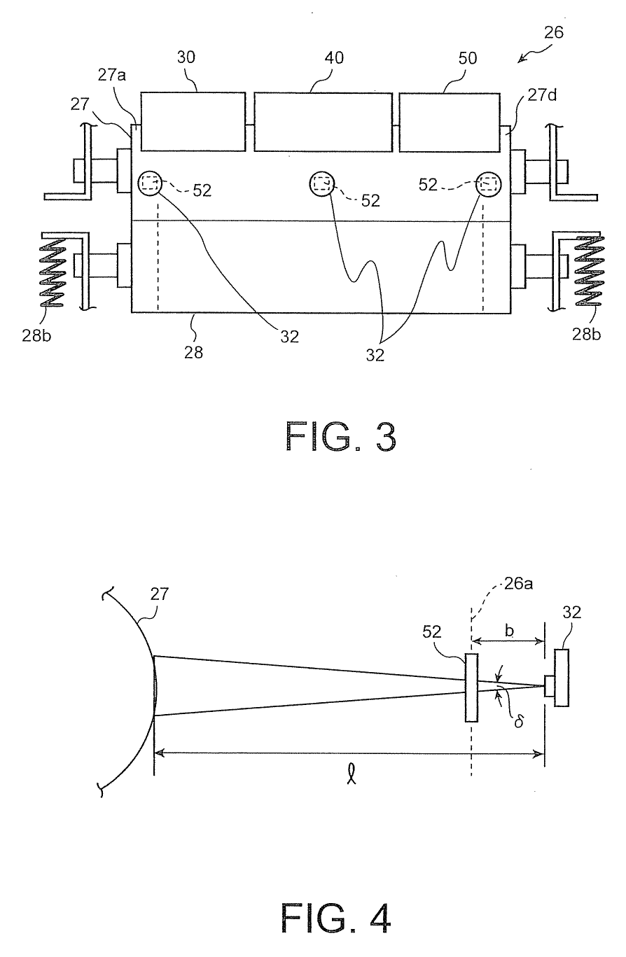

Next, the fixing device 26 will be described. FIG. 2 is a schematic block diagram of the fixing device 26 viewed in the axial direction of a heat roller 27, and FIG. 3 is a schematic layout of the fixing device 26 viewed in the perpendicular direction to the shaft of the heat roller 27, and FIG. 4 is a schematic illustration for an infrared temperature sensor 32 and an infrared transmission filter 52. The fixing device 26 of this embodiment, to control the temperature of the heat roller 27 with high precision at high speed, uses the infrared temperature sensor 32.

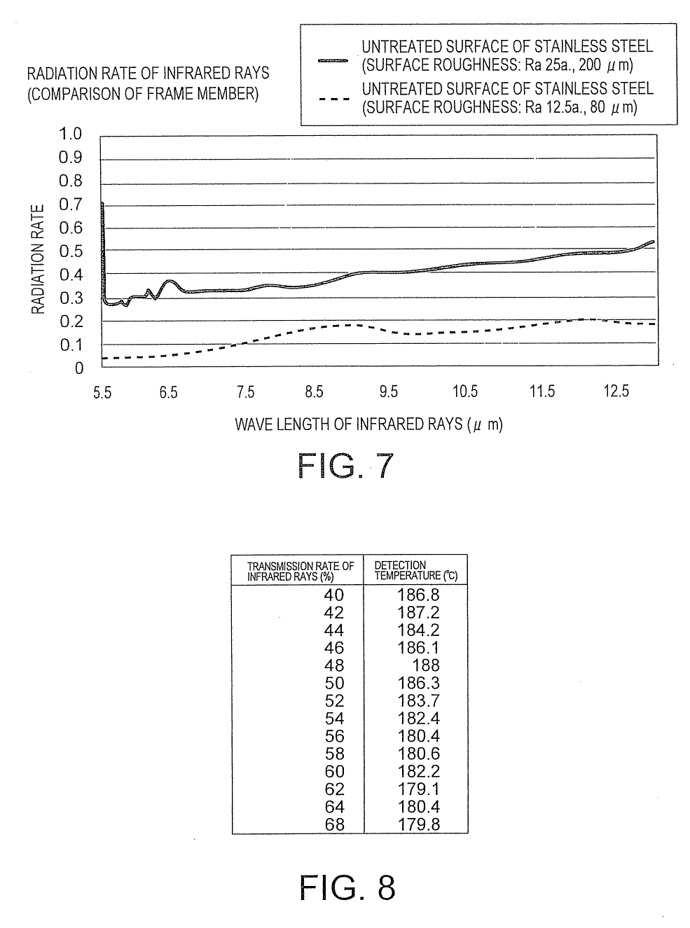

In this embodiment, the inner surfaces of an upper frame 26a and a lower frame 26b which are support frames of the fixing device 26 are made of stainless steel having roughness of Ra 12.5 of the surface which is a mirror surface. The inner surfaces of the upper and lower frames 26a and 26b are formed as a mirror surface like this, so that radiation of infrared-ray energy from the upper and lower frames 26a and 26b is prevented. When the material of the upper and lower frames 26a and 26b is changed, compared with the comparative example made of stainless steel with a thickness of 20 μm having surface roughness of Ra 25 indicated by a solid line in FIG. 7, in the upper and lower frames 26a and 26b of this embodiment indicated by a dotted line in FIG. 7 having a mirror surface with surface roughness of Ra 12.5 made of stainless steel with a thickness of 80 μm, the infrared radiation rate can be lowered.

The upper and lower frames 26a and 26b of the fixing device 26 respectively support a heat roller 27 and a pressure roller 28 which are heated members. The heat roller 27 rotating in the direction of an arrow of r and the pressure roller 28 which makes contact with the heat roller 27 and rotates in the direction of an arrow s compose a fixing roller pair.

The heat roller 27 has a metallic conductive layer around the core bar via foamed rubber. The pressure roller 28 has a core bar which is covered with a surface layer such as silicone rubber or fluororubber. The pressure rubber 28, via a pressure arm 28a rotating around a support point 28c, pushes up a shaft 28d toward the heat roller 27 by a pressure spring 28b. By doing this, the pressure roller 28 is pressed to the heat roller 27, thus between the heat roller 27 and the pressure roller 28, a nip 29 with a fixed width is formed.

On the outer periphery of the heat roller 27, inductive heating coils 30, 40, and 50 which are heating source members for a 100 V power source to heat the heat roller 27 are installed via a gap of about 1.5 mm. The inductive heating coils 30, 40 and 50 are in an almost coaxial shape with the heat roller 27.

The inductive heating coils 30, 40 and 50, when drive currents are supplied respectively, generate magnetic fields. By the magnetic fields, an eddy current is generated in the metallic conductive layer (not drawn) of the surface of the heat roller 27, thus the heat roller 27 is heated. The inductive heating coils 30, 40, and 50 are divided and arranged in the longitudinal direction of the heat roller 27 and heat respectively the opposite areas of the heat roller 27. The inductive heating coils 30, 40 and 50 are respectively controlled for the power value according to the frequencies of the drive currents, and by the power values of the inductive heating coils 30, 40 and 50, the heat value of the metallic conductive layer of the heat roller 27 is changed, thus the heat roller 27 is controlled for the temperature.

Furthermore, on the outer periphery of the heat roller 27, in the rotational direction of the arrow r of the heat roller, a thermistor 33 for detecting an error in the surface temperature of the heat roller 27 and interrupting heating, a separation pawl 31 for preventing the sheet P after fixing from winding round, and a cleaning roller 34 are installed. The thermistor 33 makes contact with the non-image forming areas at both ends of the heat roller 27 and detects the temperature of the heat roller 27.

In the neighborhood of the upper frame 26a, the infrared temperature sensor 32 for detecting the temperature of the heat roller 27 in non-contact is installed. The infrared temperature sensor 32 is arranged in each corresponding area to the respective inductive heating coils 30, 40 and 50. The infrared temperature sensors 32 detect the surface temperatures of the heat roller 27 between the inductive heating coils 30, 40 and 50 and the nip 29 installed between the heat roller 27 and the pressure roller 28.

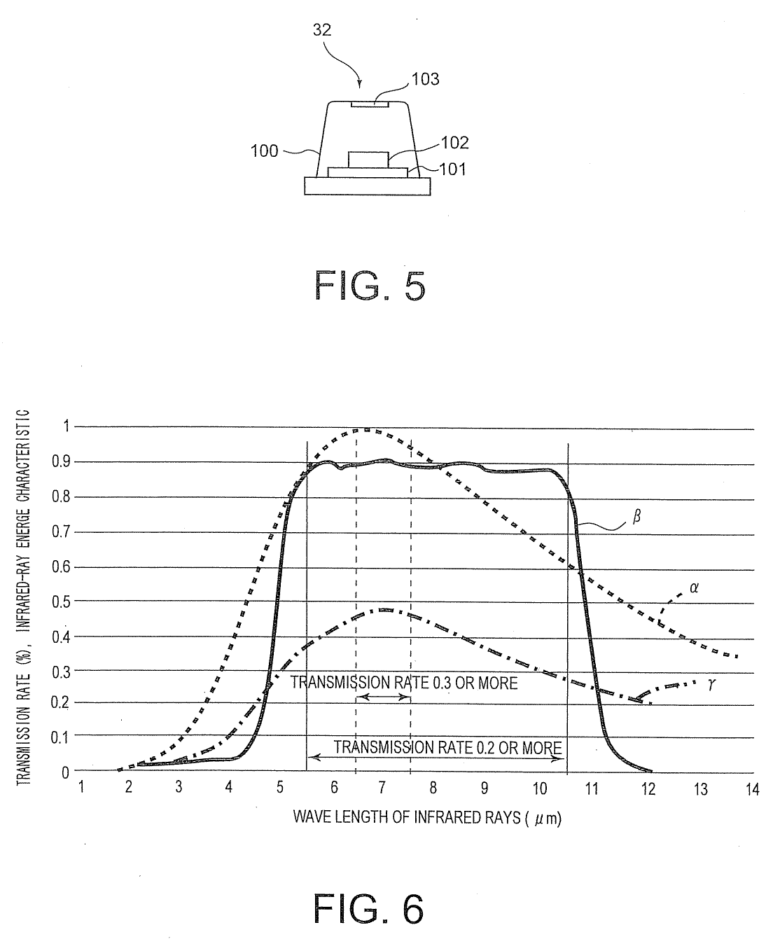

Each of the infrared temperature sensors 32, as shown in FIG. 5, has a thermopile 102 composed of many thin film thermocouples made of polysilicone and aluminum connected in series on a heat resistant silicone substrate 101 installed in a housing 100. The housing 100 has a silicone lens 103 and focuses infrared rays from the heat roller 27 to the thermopile 102. The infrared temperature sensors 32 of the thermopile type receive infrared rays, calculate the infrared-ray energy, and detect temperature change in the hot contact portion generated in the thermopile 102 as starting power of the thermocouple.

Between the heat roller 27 and the infrared temperature sensors 32, infrared transmission filters 52 with an infrared-ray transmission rate of 53% which are a prevention member is installed. The infrared transmission filters 52 prevent maldetection of the temperature of the heat roller 27 caused by incidence of infrared rays from the portions other than the heat roller 27 to the infrared temperature sensors 32 of the non-contact type. The infrared transmission filters 52 are attached to the side of the upper frame 26a. Each of the infrared transmission filters 52 is obtained by forming an optical multilayer film by vacuum vapor deposition on a heat resistant glass substrate with a thickness of 1 mm and an infrared-ray transmission rate of 53% (a blue substrate and a white substrate included). The optical multilayer film, when the surface temperature of the heat roller 27 is detected, prevents infrared rays radiated from other than the heat roller 27 from entering the infrared temperature sensors 32. Therefore, an incorrect detection of the infrared temperature sensors 32 is prevented.

Here, the principle of the infrared transmission filters 52 will be described. For example, when the temperature of the heat roller 27 of the fixing device 26 is 180° C., the detection results of the infrared temperature sensors 32 are 180° C. theoretically. However, inside the fixing device 26, when the temperature of the heat roller 27 is 180° C., the insides of the frames 26a and 26b therearound are also heated to about 70 to 80° C. A contact-type sensor such as a thermistor, even in such a state, can detect that the temperature of the heat roller 27 is 180° C.

However, the non-contact type infrared temperature sensors 32, when measuring the temperature of the heat roller 27 free of a filter in such a state, detect 185 to 186° C. higher than the actual temperature. Therefore, the detection results by the infrared temperature sensors 32 free of a filter exceed the error tolerance (for example, when the temperature of the heat roller 27 is 180° C., 180±2 to 3° C. is within the error tolerance) when controlling the temperature of the heat roller 27. Therefore, a filter varying in the transmission rate with the wave length range is used and the temperature detection test of the heat roller 27 was executed by the infrared temperature sensors 32. As a result, it is ascertained that the infrared transmission filters 52 shown in FIG. 6 having a transmission rate of about 0.2 (20%) or more in the whole zone within the wave length range from 5.5 μm to 10.6 μm almost corresponding to the temperature range from 0° C. to 250° C. of the heat roller 27 are used, and if the transmission rate in the wave length zones from 5.5 μm to 6.5 μm and from 7.5 μm to 10.6 μm is about 0.2 (20%) or more, and the transmission rate in the wave length zone from 6.5 μm to 7.5 μm is about 0.3 (30%) or more, and the transmission rate in the other wave length ranges is 0.1 (10%) or less, the detection results of the infrared temperature sensors 32 are within the error tolerance. In FIG. 6, a dotted line ∂ indicates an infrared-ray energy distribution of the heat roller 27 heated to 180° C., and a solid line β indicates transmission characteristics of the infrared transmission filters 52, and an alternate long and short dash line γ indicates transmission characteristics of the infrared transmission filter of the comparative example.

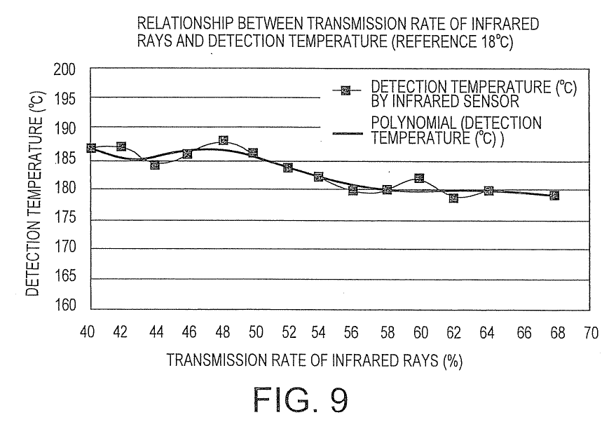

However, in the infrared transmission filters 52, the infrared transmission rate thereof influences the detection results of the infrared temperature sensors 32. Therefore, the infrared transmission rate of the infrared transmission filters 52 within the wave length range from 5.5 μm to 10.6 μm is changed and the temperature detection test of the heat roller 27 was executed by the infrared temperature sensors 32. As a result, as shown in FIGS. 8 and 9, it is ascertained that when the infrared transmission rate of the infrared transmission filters 52 is 4.5% or more, the detection temperature by the infrared temperature sensors 32, for the detection temperature by a polynomial, is almost within the error tolerance.

Therefore, in this embodiment, the infrared transmission filters 52 shown in FIG. 6 in which the transmission rate in the whole zone within the wave length range from 5.5 μm to 10.6 μm is about 0.2 or more, and the transmission rate in the wave length zones from 5.5 μm to 6.5 μm and from 7.5 μm to 10.6 μm is about 0.2 (20%) or more, and the transmission rate in the wave length zone from 6.5 μm to 7.5 μm is about 0.3 (30%) or more, and the transmission rate in the other wave length ranges is 0.1 (10%) or less is used. Further, with respect to the infrared transmission filters 52, instead of cutting or transmitting various wave lengths by one filter, it is possible to overlap a plurality of infrared transmission filters having different transmission wave length zones and obtain a desired infrared transmission zone.

To attach the infrared transmission filters 52 to the upper frame 26a, a mold member including white and colorless glasses is used. The mold member may not include glasses. The size of the infrared transmission filters 52 is set according to a light focusing angle δ of the silicone lens 103 of the infrared temperature sensor 32 shown in FIG. 4, a distance b from the infrared temperature sensor 32 to the infrared transmission filter 52, and a distance l from the infrared temperature sensor 32 to the heat roller 27. For example, when the light focusing angle β of the infrared temperature sensor 32 is 8°, and the distance b is 15 mm, and the distance l is 40 mm, the size of the infrared transmission filters 52 is set to 1.1 mm×1.1 mm or more.

When the size of the infrared transmission filters 52 is set like this, the infrared temperature sensors 32 are projected to the periphery of the infrared transmission filters 52, thus there is no risk that the temperature of the side wall of the upper frame 26a may be detected.

Further, in this embodiment, the inner surfaces of the upper and lower frames 26a and 26b of the fixing device 26 are formed so as to be a mirror surface, thus the infrared-ray energy radiated from other than the heat roller 27 is reduced by the fixing device 26.

Next, the operation of the invention will be described. When the power source of the image forming apparatus 1 is turned on, a drive current is given to the inductive heating coils 30, 40 and 50 and the heat roller 27 is warmed up in the whole area in the scanning direction which is the axial direction of the heat roller 27. The surface temperature of the heat roller 27 is detected by the infrared temperature sensors 32 and thermistor 33. From the detection results by the infrared temperature sensors 32, when the heat roller 27 reaches 180° C. and enters the ready state, according to the detection results of the infrared temperature sensors 32 and thermistor 33, the output power of the inductive heating coils 30, 40, and 50 are controlled so as to keep the ready temperature.

Into the infrared temperature sensors 32, via the infrared transmission filters 52 of the transmission characteristic indicated by the solid line β shown in FIG. 6, the infrared-ray energy from the heat roller 27 enters. Further, at this time, the inner surfaces of the upper and lower frames 26a and 26b are mirror surfaces, so that during detection of the temperature of the heat roller 27, no infrared-ray energy is radiated from the inner surfaces of the upper and lower frames 26a and 26b. Namely, to the infrared temperature sensors 32, infrared rays having an energy distribution in which the wave length zone not influencing temperature detection is cut enters. Therefore, the temperature of the heat roller 27 detected by the infrared temperature sensors 32 is within the error tolerance.

When the surface temperature of the heat roller 27 reaches the ready state from the detection results of the infrared temperature sensors 32, by an instruction of the printing operation, the image forming process is started. In the image forming unit 2, the photosensitive drum 11 rotating in the direction of the arrow q is uniformly charged by the main charger 12, and a laser beam according to the document information is radiated by the laser exposure device 13, and an electrostatic latent image is formed. Next, the electrostatic latent image is developed by the developing device 14 and a toner image is formed on the photosensitive drum 11.

The toner image on the photosensitive drum 11 is transferred to the sheet P by the transfer charger 16. Next, the sheet P is separated from the photosensitive drum 11 and reaches the fixing device 26. The sheet P conveyed to the fixing device 26 is heated to, for example, 160° C. which is a fixable temperature and is inserted through the nip 29 between the heat roller 27 rotating in the direction of the arrow r and the pressure roller 28 rotating in the direction of the arrow s, thus the toner image is heated, pressurized, and fixed.

During fixing of the toner image, the fixing device 26 detects the surface temperature of the heat roller 27 by the infrared temperature sensors 32 and thermistor 33. Also during this period, similarly to the period of warming up, the infrared temperature sensors 32 detect the surface temperature of the heat roller 27 via the infrared transmission filters 52. According to the detection results, the supply power of the induced heating coils 30, 40 and 50 is adjusted. By doing this, the surface temperature of the heat roller 27 can be controlled with high precision so as to be kept at 180° C.±10° C. and the toner image can be fixed satisfactorily onto the sheet P.

Further, when the thermistor 33 detects an error, it immediately turns off the supply power of the inductive heating coils 30, 40, and 50. When the predetermined image forming process is finished, according to the detection results of the surface temperature of the heat roller 27 by the infrared temperature sensors 32, the thermistor 33 controls the output power of the inductive heating coils 30, 40, and 50 and keeps the heat roller 27 in the ready state.

According to this embodiment, the infrared transmission filters 52 are installed between the heat roller 27 and the infrared temperature sensors 32 and the wave lengths other than the zone equivalent to 0° C. to 250° C. are cut. By doing this, infrared rays radiated from other than the heat roller 27 are prevented from entering the infrared temperature sensors 32. Therefore, the detection results by the infrared temperature sensors 32 can be controlled within the error tolerance of temperature control and the surface temperature of the heat roller 27 can be detected with high precision. As a result, the supply power of the inductive heating coils 30, 40 and 50 is adjusted with high precision, thus the temperature of the heat roller 27 can be controlled with high precision and the image quality can be improved by the satisfactory fixing property. Furthermore, the inner surfaces of the upper and lower frames 26a and 26b are formed as a mirror surface, thus the radiation of the infrared-ray energy from the upper and lower frames 26a and 26b is prevented. By doing this, the infrared-ray energy entered to the infrared temperature sensors 32 from other than the heat roller 27 can be reduced.

Next, the second embodiment of the present invention will be explained. In the second embodiment, unlike the first embodiment, in place of the infrared transmission filters, the space between the heat roller 27 and the infrared temperature sensors 32 is covered with a duct. Therefore, in the second embodiment, to the same components as those explained in the first embodiment, the same numerals are assigned and the detailed explanation thereof will be omitted.

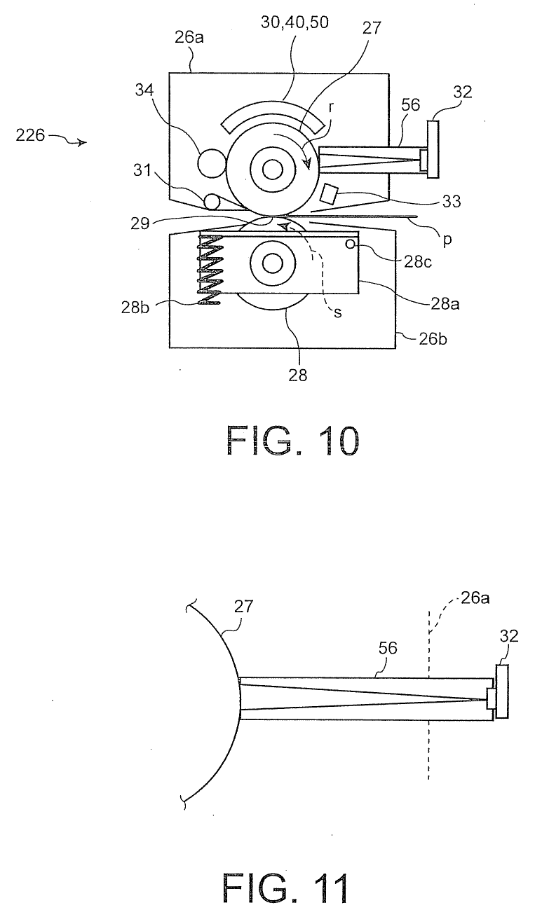

In a fixing device 226 in this embodiment, infrared rays radiated from the areas other than the heat roller 27 is prevented from entering the infrared temperature sensors 32 and the surface temperature of the heat roller 27 is detected with high precision by the infrared temperature sensors 32. Therefore, in this embodiment, as shown in FIGS. 10 and 11, a duct 56 which is a prevention member is installed between the heat roller 27 and the infrared temperature sensors 32. The inner surface of the duct 56 is composed of stainless steel having a mirror surface with a surface roughness Ra of 12.5a. The thickness of stainless steel is 80 μm. The outer periphery of the stainless steel is covered with a heat-resistant resin or a heat insulating member.

The duct 56 leads the infrared-ray energy radiated from the surface of the heat roller 27 directly to the infrared temperature sensors 32. Further, the duct 56 prevents infrared-ray energy radiated and reflected irregularly from other than the heat roller 27 in the fixing device 226 from entering the infrared temperature sensors 32. When the heat roller 27 is in operation, the duct 56 close to the heat roller 27 raises the temperature. However, the inner surface of the duct 56 is a mirror surface, so that no infrared rays are radiated from the surface of the duct 56. Therefore, the infrared temperature sensors 32 are not influenced by radiation in the area unnecessary for temperature control of the heat roller 27 and can detect only the surface temperature of the heat controller 27 with high precision.

According to this embodiment, similarly to the first embodiment, the inner surfaces of the upper and lower frames 26a and 26b are mirror surfaces and radiation of infrared rays from the upper and lower frames 26a and 26b is prevented. Further, between the heat roller 27 and the infrared temperature sensors 32, the duct 56 having the inner surface of a mirror surface is installed and into the infrared temperature sensors 32, only the infrared-ray energy radiated from the surface of the heat roller 27 enters. Therefore, the infrared temperature sensors 32, similarly to the first embodiment, free of an incorrect detection of temperature caused by detection of infrared-ray energy radiated and reflected irregularly from other than the heat roller 27, can detect the surface temperature of the heat roller 27 with high precision. As a result, the temperature of the heat roller 27 can be controlled with high precision and the image quality can be improved by the satisfactory fixing property.

Further, the present invention is not limited to the embodiments aforementioned and can be changed variously within the scope of the present invention. For example, the kind of the non-contact temperature detection member and response time are not restricted. Further, with respect to the mirror surface, if it does not radiate infrared rays, the material and surface roughness thereof are not restricted. Furthermore, in the first embodiment, the size of the infrared transmission filters and the thickness thereof are not restricted. Further, the material of the substrates of the infrared transmission filters is also optional and for example, in place of the heat-resistant glass substrate, if a heat-resistant silicone substrate is used, the transmission rate of infrared rays can be improved much more. Further, the structure and material of the duct of the second embodiment are not restricted and ABS resin or PPS resin used for the mirror-finished inner surface of the duct is acceptable. Furthermore, the heating source is not limited to the inductive heating coil, that is, a heater may be used to heat and the inductive heating coil may be installed inside the heated member.

What is claimed is:

1. A fixing device of an image forming apparatus comprising:
a heated member to make contact with a fixed medium and fix a toner image on the fixed medium;
a heat source member to heat the heated member;
a non-contact temperature detection member to detect a surface temperature of the heated member; and
a prevention member provided between the heat source member and the temperature detection member to prevent infrared rays from other than the heated member from entering the temperature detection member.

2. The fixing device of an image forming apparatus according to claim 1, wherein the temperature detection member is an infrared temperature sensor of a non-contact thermopile type and the prevention member is an optical multilayer film filter having a transmission rate of 20% or more in the wave length zones from 5.5 μm to 6.5 μm and from 7.5 μm to 10.6 μm, a transmission rate of 30% or more in the wave length zone from 6.5 μm to 7.5 μm, and a transmission rate of 10% or less in the other wave length ranges.

3. The fixing device of an image forming apparatus according to claim 2, wherein the optical multilayer film filter comprises a plurality of overlapped optical multilayer film filters having different light transmission rates.

4. The fixing device of an image forming apparatus according to claim 2, wherein the optical multilayer film filter comprises a heat-resistant glass substrate covered with an optical multilayer film.

5. The fixing device of an image forming apparatus according to claim 2, wherein the optical multilayer film filter is composed of a heat-resistant silicone substrate covered with an optical multilayer film.

6. The fixing device of an image forming apparatus according to claim 2, wherein in a main body of the image forming apparatus, an inner surface of a support frame to support the heated member is a mirror surface.

7. The fixing device of an image forming apparatus according to claim 1, wherein the temperature detection member is an infrared temperature sensor of a non-contact thermopile type and the prevention member is a duct provided between the heated member and the infrared temperature sensor.

8. The fixing device of an image forming apparatus according to claim 7, wherein the duct comprises a heat-resistant resin having a mirror-finished inner surface.

9. The fixing device of an image forming apparatus according to claim 7, wherein the duct comprises a metallic plate having a mirror-finished inner surface.

10. The fixing device of an image forming apparatus according to claim 7, wherein in the main body of the image forming apparatus, an inner surface of a support frame to support the heated member is a mirror surface.

11. A fixing device of an image forming apparatus comprising:
heated means for making contact with a fixed medium and fixing a toner image on the fixed medium;
heat source means for heating the heated means;
non-contact temperature detection means for detecting a surface temperature of the heated means; and
frame means having an inner surface including at least one part as a mirror surface for supporting the heated means in a main body of the image forming apparatus.

12. A fixing method for an image forming apparatus comprising:
a step of preventing infrared rays radiated from other than a heated member heated by a heat source member for making contact with a fixed medium and fixing a toner image on the fixed medium from entering a temperature detection member; and
a step of detecting infrared rays entering the temperature detection member after the infrared rays radiated from other than the heated member are prevented.

13. The fixing method for an image forming apparatus according to claim 12, wherein the step of preventing the infrared rays radiated from other than the heated member from entering the temperature detection member is executed by passing the infrared rays through an optical multilayer film filter.

14. The fixing method for an image forming apparatus according to claim 13, wherein the optical multilayer film filter is set so as to have a transmission rate of 20% or more in the wave length zones from 5.5 μm to 6.5 μm and from 7.5 μm to 10.6 μm, a transmission rate of 30% or more in the wave length zone from 6.5 μm to 7.5 μm, and a transmission rate of 10% or less in the other wave length ranges.

15. The fixing method for an image forming apparatus according to claim 12, wherein the step of preventing the infrared rays radiated from other than the heated member from entering the temperature detection member is executed by forming an inner surface of a support frame of the heated member as a mirror surface.

16. The fixing method for an image forming apparatus according to claim 12, wherein the step of preventing the infrared rays radiated from other than the heated member from entering the temperature detection member is executed by covering a route of the infrared rays from radiation from the heated member to arrival at the temperature detection member with a duct.
